(19) United States
(12) Patent Application Publication
(10) Pub. No.: US 2011/0109129 A1
(43) Pub. Date: May 12, 2011

(54) ATTACHMENT SYSTEM FOR SECURING OBJECTS TO THE BACKREST OF A MOTOR VEHICLE SEAT

(75) Inventor: Martin BRILL, Oppenheim (DE)

(73) Assignee: GM GLOBAL TECHNOLOGY OPERATIONS, INC., Detroit, MI (US)

(21) Appl. No.: 12/890,191

(22) Filed: Sep. 24, 2010

(30) Foreign Application Priority Data
Sep. 30, 2009 (DE) 102009043767.3

(51) Int. Cl. B60N 2/44

(52) U.S. Cl. 297/188.04

(57) ABSTRACT

An attachment element is provided for securing objects to the backrest of a motor vehicle seat. The attachment element is arranged on the backrest. The attachment element is designed as a carrier rail, wherein the object or objects secured to the attachment element can be slidably arranged on the attachment element.

### CROSS-REFERENCE TO RELATED APPLICATION

This application claims priority to German Patent Application No. 102009043767.3, filed Sep. 30, 2009, which is incorporated herein by reference in its entirety.

### TECHNICAL FIELD

The invention relates to an attachment system for securing objects to the backrest of a motor vehicle seat.

### BACKGROUND

An attachment system is known, for example, from DE 103 40 321 A1. An adapter is provided for securing various objects to the backrest of vehicle seats equipped with headrests, wherein the carrying rods of the headrests can be inserted at guiding height with collar bodies formed at the top, and the adapter is secured to the upper side of the backrest in the area of the headrest. The carrying rods of the headrest pass through openings in the adapter. The adapter can have secured to it an adapter insertion module, to which an object can be secured, fixed in place by bearings.

The disadvantage to such an attachment system is that the objects secured thereto can only be rather inflexibly secured to the attachment system due to the bearing-fixed attachment.

Therefore, at least one object of the invention is to provide an attachment system for securing objects to the backrest of a motor vehicle, which is characterized by a high flexibility and high user friendliness.

### SUMMARY

The attachment system according to an embodiment of the invention for securing objects to the backrest of a motor vehicle seat has an attachment element arranged on the backrest, wherein the attachment element is designed as a carrier rail, wherein the objects secured to the attachment element can be slidably arranged on the attachment element.

As a result, the objects secured to the attachment element can be flexibly shifted along the carrier rail, so that the objects are not secured to the attachment element in a bearing-fixed manner. For example the objects secured to the attachment element can be tables, monitors, cup holders, hooks, rubbish bins, backrest pockets, book holders or the like. The capacity to shift the objects along the attachment element makes it possible to slide the objects into the desired position on the attachment element, wherein several objects can also be simultaneously secured to the attachment element if needed, wherein the objects can to this end be correspondingly shifted along the attachment element designed as a carrier rail. This makes the attachment system according to the invention especially flexible and user-friendly.

In an embodiment of the invention, the attachment element has at least one guiding area with a back-cut. The objects are here guided inside the guiding area while secured to the attachment element, wherein the objects are retained inside the guiding area by the back-cut provided on the guiding region. In this case, the objects to be secured are preferably provided with a corresponding adapter, which can be arranged, in particular hooked, in the guiding area of the carrier rail. The attachment element can further have two guiding areas interconnected by a web, wherein the web can have two ribs projecting in opposite directions, forming a respective back-cut in the two guiding areas. The back-cut and guidance within the guiding areas or capacity to shift within the guiding area makes it possible to reliably secure the objects to the attachment element.

The attachment element further preferably has at least one introduction groove for securing the objects to the attachment element. The introduction groove is preferably provided at one end of the carrier rail along its longitudinal axis, wherein the introduction groove is preferably provided in the region of the guiding area. As a result, the objects can be easily slipped onto the attachment element designed as a carrier rail.

However, it is also possible for no introduction groove to be provided. The objects can then be secured to an adapter, which consists of an elastic material with an elastically bendable retaining claw, which can be hooked into the back-cut of the guiding rail. In the process, a connection with the attachment element or detachment from the attachment element takes place by elastically bending the adapter, for example along a central section where two retaining claws are situated, until the retaining claws can be hooked into or unhooked from the guiding rails. As a result, the objects can be secured directly in the center of the attachment element, without having to be slipped onto the attachment element by way of an introduction groove.

It is further provided that the attachment element is arranged on the backrest with its longitudinal axis transverse to the vehicle longitudinal axis. As a result, objects arranged on the attachment element or carrier rail can be laterally shifted. However, it is further also conceivable to arrange the attachment element on the backrest with its longitudinal axis vertical to the vehicle longitudinal axis.

In another embodiment of the invention, the attachment element has at least one latching element. The latching element can be used to fix the objects in a position on the attachment element, so that the objects cannot unintentionally slide back and forth on the attachment element. If the objects on the attachment element are to be shifted, the latching element can be released again, restoring the capability of the objects to slide.

Further, it is preferably provided that the attachment element is permanently secured to the backrest. The attachment element is here preferably non-positively or positively secured to the backrest, for example by means of screws, welds or adhesive bonds.

In another advantageous embodiment of the invention, the attachment element can be secured to a headrest mount. The headrest mount is situated directly on the backrest of the motor vehicle seat, wherein the headrest provided for the motor vehicle seat can be secured to the headrest mount. If the attachment means is secured to the headrest mount, the backrest need not be additionally machined so that the attachment element can be secured there. Further, it is possible, by securing the attachment element to the headrest mount, for the attachment element to be detachably secured, so that the attachment element can be secured to the backrest or removed from it, as the respective situation requires.

The embodiments of the invention further relates to a vehicle seat, encompassing an attachment system as designed and further developed above for attaching objects to a backrest of the vehicle seat.

### BRIEF DESCRIPTION OF THE DRAWINGS

The present invention will hereinafter be described in conjunction with the following drawing figures, wherein like numerals denote like elements, and:

FIG. 1 is a diagrammatic representation of an attachment system according to an embodiment of the invention;

FIG. 2 is a diagrammatic representation of the attachment system depicted on FIG. 1, with a hook element and cup holder arranged on it;

FIG. 3 is a diagrammatic representation of the attachment system depicted on FIG. 1, with a table arranged on it; and

FIG. 4 is another diagrammatic representation of the attachment system depicted on FIG. 1, with a monitor arranged on it.

### DETAILED DESCRIPTION

The following detailed description is merely exemplary in nature and is not intended to limit application and uses. Furthermore, there is no intention to be bound by any theory presented in the preceding background or summary or the following detailed description.

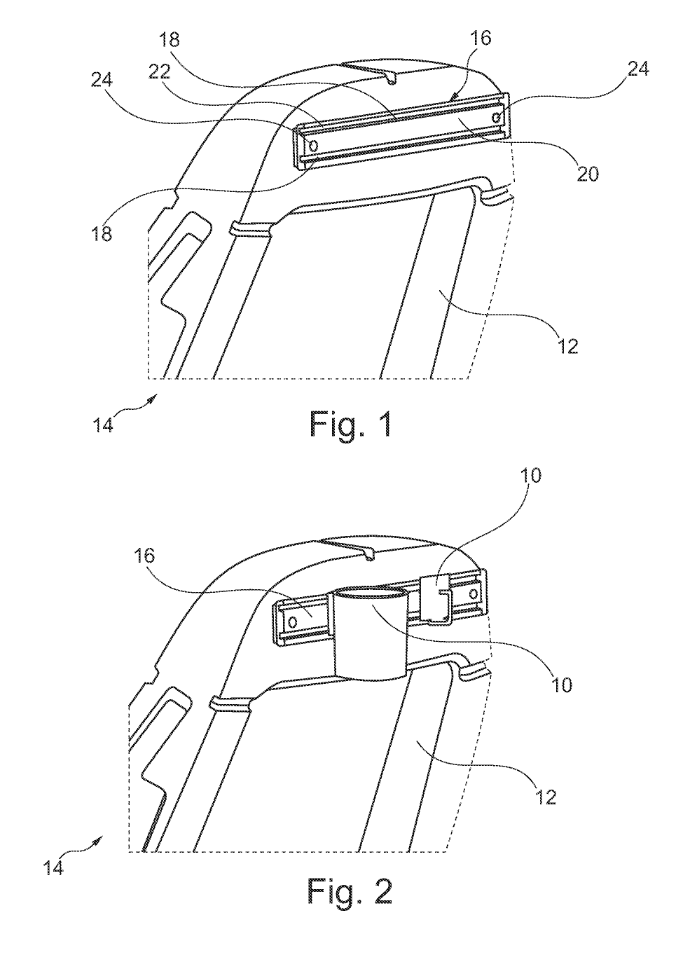

FIG. 1 shows an attachment system according to the invention for securing objects 10 to a backrest 12 of a motor vehicle seat 14. The attachment system has an attachment element 16, which is arranged on the backrest 12 of the motor vehicle seat 14. The attachment element 16 is designed as a carrier rail, wherein the objects 10 secured to the attachment element 16, as depicted on FIGS. 2 to 4, can be arranged so as to slide on the attachment element 16. The attachment element 16 designed as a carrier rail has two guiding areas 18 in the example presented here, which are situated parallel to each other, and separated from each other by a centrally arranged web 20, wherein the web has two ribs 22 projecting in opposite directions, which form back-cuts in the guiding areas 18 so that the objects 10 can be hooked into these back-cuts in the guiding areas 18 themselves or using an adapter provided for this purpose, allowing them to be shifted inside the attachment element 16. The attachment element 16 is here secured to the backrest 12 by two screws 24. The attachment element 16 designed as a carrier rail is secured to the backrest 12 with its longitudinal axis transverse to the vehicle longitudinal axis.

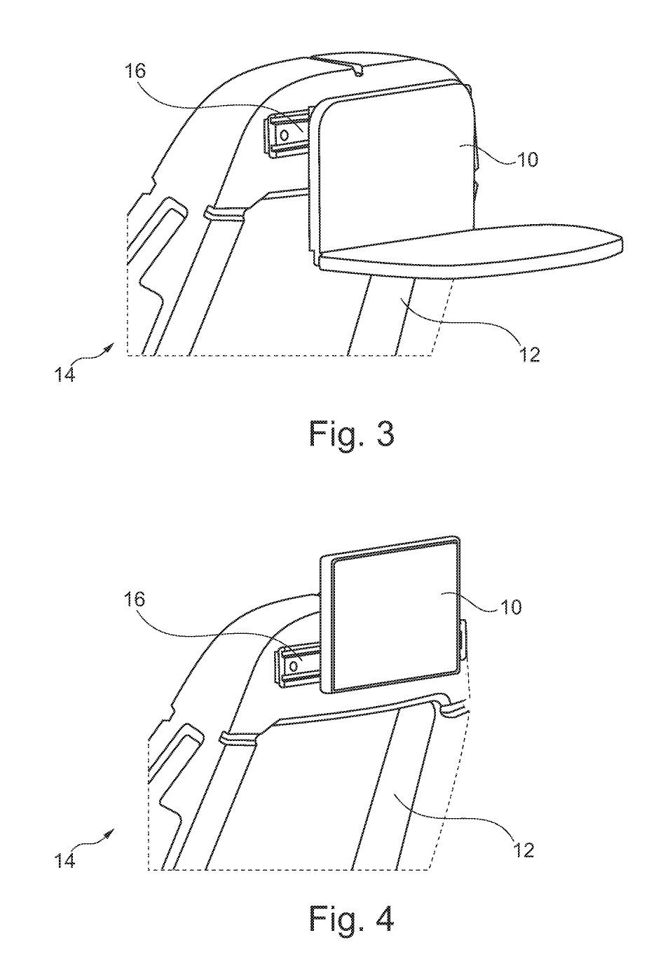

Various objects 10 are shiftably arranged on the attachment element 16 on FIG. 2 to 4, with FIG. 2 presenting a hook element and cup, FIG. 3 a table, and FIG. 4 a monitor.

If such an attachment system is provided on several vehicle seats 14 within a motor vehicle, the objects 10 between the individual attachment systems on the different vehicle 14 seats can be interchanged, so that the objects 10 can be secured to different vehicle seats 14.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. An attachment system for securing an object to a backrest of a seat of a motor vehicle, comprising:
a first guiding area;
a second guiding area;
an attachment element formed by the first guiding area and the second guiding area and arranged on the backrest,
wherein the attachment element is adapted to slidably secure the object.

2. The attachment system according to claim 1, wherein the attachment element the first guiding area comprises a back-cut.

3. The attachment system according to claim 1, wherein the attachment element comprises an introduction groove adapted to secure the object to the attachment element.

4. The attachment system according to claim 1, wherein the attachment element is arranged on the backrest with a longitudinal axis transverse to a vehicle longitudinal axis of the motor vehicle.

5. The attachment system according to claim 1, wherein the attachment element comprises a latching element.

6. The attachment system according to claim 1, wherein the attachment element is permanently secured to the backrest.

7. The attachment system according to claim 1, wherein the attachment element is adapted to mount to a headrest mount.

8. A vehicle, comprising:
a seat;
a backrest of the seat; and
an attachment system for securing an object to the backrest of the seat, comprising:
a first guiding area;
a second guiding area;
an attachment element formed by the first guiding area and the second guiding area and arranged on the backrest,
wherein the attachment element is adapted to slidably secure the object.

9. The vehicle according to claim 8, wherein the attachment element the first guiding area comprises a back-cut.

10. The vehicle according to claim 8, wherein the attachment element comprises an introduction groove adapted to secure the object to the attachment element.

11. The vehicle according to claim 8, wherein the attachment element is arranged on the backrest with a longitudinal axis transverse to a vehicle longitudinal axis of the vehicle.

12. The vehicle according to claim 8, wherein the attachment element comprises a latching element.

13. The vehicle according to claim 8, wherein the attachment element is permanently secured to the backrest.

14. The vehicle according to claim 8, wherein the attachment element is adapted to mount to a headrest mount.
